(19) United States
(12) Patent Application Publication
(10) Pub. No.: US 2019/0344284 A1
(43) Pub. Date: Nov. 14, 2019

(54) Belt Conveying Device with Crushing and Dust-proof functions for Agglomerated Finely divided materials

(71) Applicant: Xiaomin WANG, Hong Kong (HK)

(72) Inventor: Xiaomin WANG, Hong Kong (HK)

(21) Appl. No.: 16/055,177

(22) Filed: Aug. 6, 2018

(30) Foreign Application Priority Data
May 14, 2018 (CN) 201810457485.5

(51) Int. Cl. B02C 23/04; B02C 4/30; B02C 23/10; B01J 2/26; C22B 1/24; C22B 1/16

(52) U.S. Cl. CPC B02C 23/04; B02C 4/30; B02C 23/10; B02C 2013/28645; C22B 1/24; C22B 1/16; B01J 2/26

(57) ABSTRACT

The invention relates to a belt conveying device with crushing and dust-proof functions for agglomerated finely divided materials which includes a base, a rolling bracket, a conveyor belt, a crushing and dust removing mechanism, and a conveyor belt cleaning mechanism. The base includes a fixed seat body, a movable seat body, and a hydraulic cylinder. The rolling bracket includes a supporting plate, a rotating shaft, and supporting rods. The conveyor belt includes a belt-shaped conveyor belt body and induction teeth. The crushing and dust removing mechanism includes an inner sleeve, an outer sleeve, a first air pump, an ion fan, and a mixing chamber. The conveyor belt cleaning mechanism includes a cylinder, a stencil, a cleaning mechanism, and a second air pump. It has advantages of having simple and reasonable structure, easy to use, high degree of intelligence, automatically correcting deviation of conveyor belt and cleaning the conveyor belt and good dust-proof effect, which effectively solves the problem of jeopardizing the health of workers due to the dust caused at the time of conveying finely divided materials.

### FIELD OF THE INVENTION

The invention relates to mechanical equipment for conveying material. In particular, the invention relates to a belt conveying device with crushing and dust-proof functions for agglomerated finely divided materials.

### BACKGROUND

As is well known, in order to better mix a variety of materials, the method often used is to first crush the materials and then mix them, but the finely divided materials are prone to agglomeration due to moisture environment during storage. Agglomerate finely divided materials not only affect the mixing effect of materials, but also increase the chance of machine failure and damage caused by sudden changes in load on the mixing machine.

When the finely divided materials are transported on the conveying equipment, the dust is easily generated due to the vibration of the conveying equipment, which jeopardizes the health of the workers. In addition, the finely divided materials are easily attached to the conveyor belt, and the materials may fall into the conveying device with the rotation of the conveyor belt, which leads to machine failure.

However, the existing conveying devices generally do not have elements for crushing the agglomerated finely divided materials, nor elements for cleaning the materials adhered on the conveyor belt. The existing dust-proof elements of conveying devices are generally simple dust cover. There is not much dust-proof effect for two workers standing on the positions where the feeding end and the discharging end of the conveying devices are present.

### SUMMARY OF THE INVENTION

The technical problem to be solved is to overcome the above-mentioned deficiency by providing a belt conveying device with crushing and dust-proof functions for agglomerated finely divided materials. It has advantages of having simple and reasonable structure, easy to use, high degree of intelligence, automatically correcting deviation of conveyor belt and cleaning the conveyor belt and good dust-proof effect, which effectively solves the problem of jeopardizing the health of workers due to the dust caused at the time of conveying finely divided materials.

The technical solution of the invention is to provide a belt conveying device with crushing and dust-proof functions for agglomerated finely divided materials which includes a base with a frame structure, a rolling bracket, a conveyor belt, a crushing and dust removing mechanism and a conveyor belt cleaning mechanism. The base includes a fixed seat body, a movable seat body which is hinged at one end to the fixed seat body, and a hydraulic cylinder of which two ends are respectively hinged with the fixed seat body and the movable seat body.

The rolling bracket is disposed on the base. The rolling bracket includes a symmetrically disposed supporting plate, a rotating shaft fixedly connected to the supporting plate at both ends, and a plurality of supporting rods fixed to the supporting plate circumferentially along the central axis of the rotating shaft. The two ends of the rotating shaft are respectively rotatably connected to the base, and are connected to a third motor disposed on the base. The central axis of the supporting rod is parallel to the central axis of the rotating shaft, and the two ends of the supporting rod are respectively provided with annular grooves.

The conveyor belt is disposed on the rolling bracket. The conveyor belt includes a belt-shaped conveyor belt body and a plurality of induction teeth uniformly arranged on the conveyor belt body for regulating the conveyor belt. The induction tooth is engaged with the annular groove on the supporting rod.

The crushing and dust removing mechanism is disposed at a feeding end of the conveying device, and the crushing and dust removing mechanism includes an inner sleeve, an outer sleeve sleeved on the inner sleeve, a first air pump, an ion fan, and a mixing chamber. A gap is defined between the inner sleeve and the outer sleeve. The mixing chamber is fixedly disposed at an upper end of the gap, and the mixing chamber is provided with a mixing cavity having a downward opening. The mixing cavity is respectively connected to the first air pump fixedly disposed on the outer sleeve, and the ion fan.

The upper end of the inner sleeve is provided with a plurality of through holes which the dust passes through. The lower end of the inner cavity of the inner sleeve is provided with a first motor. The first motor is mutually driven and connected with a plurality of turntables disposed in the middle of the inner cavity of the inner sleeve through the rotating shaft. A plurality of oblique through holes are evenly arranged on the turntable.

The conveyor belt cleaning mechanism is disposed at a discharge end of the conveying device. The conveyor belt cleaning mechanism includes a cylinder fixed to the movable seat body and having an opening facing the conveyor belt, a stencil disposed in the inner cavity of the cylinder, a cleaning mechanism fixedly arranged on the stencil, and a second air pump fixedly disposed on the cylinder. The cleaning mechanism includes a second motor fixedly disposed on the stencil, a brush and a cardan shaft for connecting the second motor and the brush. The second air pump is in communication with the lower end of the inner cavity of the cylinder, and the lower end of the inner cavity of the cylinder is provided with an electromagnetic valve for releasing material in the cylinder.

Further, the fixed seat body is provided with a plurality of legs with rollers. A locking mechanism is provided with the roller on the leg. The fixed seat body is further provided with a double-axis horizontal sensor.

Further, the movable seat body is provided with a dust-proof scaffolding frame.

The dust-proof scaffolding frame is composed of a plurality of curved supporting rod members connected to the movable seat body and a tarpaulin disposed on the supporting rod member.

Further, a dust detector is disposed at an upper end of the inner sleeve.

Further, when the turntable is punched towards the through hole, the protrusion generated. The protrusion is polished to form a blade which forms a piece structure with the turntable, for crushing the agglomerated material.

Further, the lower end of the outer sleeve is provided with a dust-proof skirt plate and a pressure release port for removing wind pressure. A dust-proof net is arranged on the pressure release port.

Further, the gap between the inner sleeve and the outer sleeve is provided with a pressure reducing plate. One end of the pressure reducing plate and the outer sleeve are hinged to each other, and the other end of the pressure reducing plate is connected to the inner sleeve by a spring.

Further, a fan filter is disposed at the junction of the second air pump and the inner cavity of the cylinder.

Further, the conveyor belt cleaning mechanism is provided with an angle sensor.

Further, the base is further provided with a controller. The controller is respectively electrically connected with a hydraulic pump for controlling the hydraulic cylinder, the first air pump, the ion fan, the first motor, the second air pump, the second motor, a double-axis horizontal sensor, a dust detector, the angle sensor, the electromagnetic valve, and the third motor.

The technical effect of the present invention is to provide a belt conveying device with crushing and dust-proof functions for agglomerated finely divided materials which includes a base, a rolling bracket, a conveyor belt, a crushing and dust removing mechanism, and a conveyor belt cleaning mechanism. The annular groove on the rolling bracket is engagement with the induction tooth on the conveyor belt to automatically regulate each other to prevent the deviation of the conveyor belt. On one hand, the crushing and dust removing mechanism crushes agglomerated finely divided materials. On the other end, the dust is absorbed into the crushing and dust removing mechanism via wind power to remove dust. The conveyor belt cleaning mechanism cleans the finely divided materials attached on the conveyor belt. The operation of each mechanism is controlled by the controller, and each sensor monitors the running status in real time with high degree of intelligence. It has advantages of having simple and reasonable structure, easy to use, high degree of intelligence, automatically correcting deviation of conveyor belt and cleaning the conveyor belt and good dust-proof effect, which effectively solves the problem of jeopardizing the health of workers due to the dust caused at the time of conveying finely divided materials.

### BRIEF DESCRIPTION OF THE DRAWINGS

The invention is illustrated by the following figures and embodiments.

FIG. 1 shows a schematic diagram of whole structure of a belt conveying device with crushing and dust-proof functions for agglomerated finely divided materials in accordance with an example embodiment.

FIG. 2 shows a schematic diagram of a base of a belt conveying device with crushing and dust-proof functions for agglomerated finely divided materials in accordance with an example embodiment.

FIG. 3 shows a schematic diagram of a roller bracket of a belt conveying device with crushing and dust-proof functions for agglomerated finely divided materials in accordance with an example embodiment.

FIG. 4 shows a schematic diagram of a conveyor belt of a belt conveying device with crushing and dust-proof functions for agglomerated finely divided materials in accordance with an example embodiment.

FIG. 5 shows a schematic diagram of the connection of the conveyor belt and the roller bracket of a belt conveying device with crushing and dust-proof functions for agglomerated finely divided materials in accordance with an example embodiment.

FIG. 6 shows a schematic diagram of a crushing and dust removing mechanism of a belt conveying device with crushing and dust-proof functions for agglomerated finely divided materials in accordance with an example embodiment.

FIG. 7 shows a schematic diagram of a mixing chamber of a belt conveying device with crushing and dust-proof functions for agglomerated finely divided materials in accordance with an example embodiment.

FIG. 8 shows a schematic diagram of a turntable of a belt conveying device with crushing and dust-proof functions for agglomerated finely divided materials in accordance with an example embodiment.

FIG. 9 shows a schematic diagram of a conveyor cleaning mechanism of a belt conveying device with crushing and dust-proof functions for agglomerated finely divided materials in accordance with an example embodiment.

FIG. 10 shows a schematic diagram of a cleaning mechanism of a belt conveying device with crushing and dust-proof functions for agglomerated finely divided materials in accordance with an example embodiment.

The reference numbers of the figures are as follows: 1: base, 11: dust-proof scaffolding frame, 12: movable seat body, 13: fixed seat body, 14: hydraulic cylinder, 15: leg, 16: controller, 17: double-axis horizontal sensor, 2: rolling bracket, 20: third motor, 21: supporting plate, 22: rotating shaft, 23: supporting rod, 231: annular groove, 3: conveyor belt, 31: conveyor belt body, 32: induction tooth, 4: crushing and dust removing mechanism, 41: inner sleeve, 411: through hold, 412: first motor, 413: turntable, 4131: oblique through hole, 414: dust detector, 42: outer sleeve, 421: pressure reducing plate, 422: pressure release port, 43: first air pump, 44: ion fan, 45: mixing chamber, 451: mixing cavity, 46: dust-proof skirt plate, 5: conveyor belt cleaning mechanism, 51: cylinder, 52: stencil, 53: cleaning mechanism, 531: second motor, 532: brush, 533: cardan shaft, 54: second air pump, 55: electromagnetic valve, 56: air filter, 57: angle sensor.

### DETAILED DESCRIPTION

The invention is illustrated in accordance with figures. The figures as simplified diagrams demonstrate the basic structures of the apparatus of embodiments of the invention. Thus, the invention is not limited to the figures.

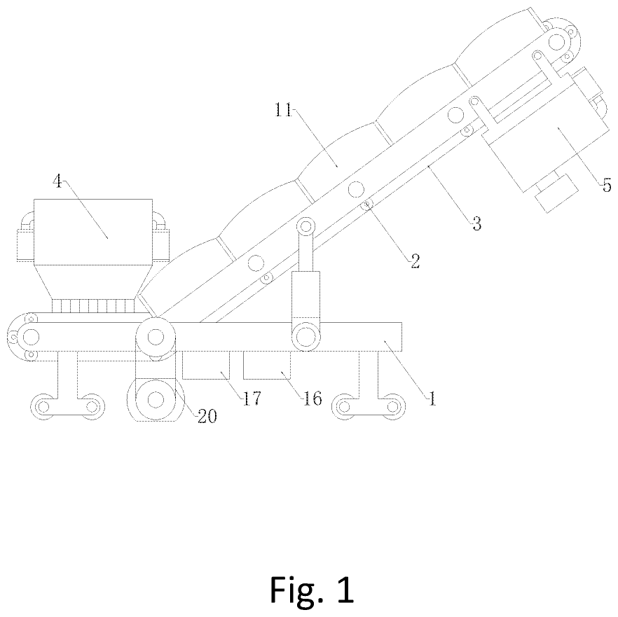

As shown in FIG. 1, a belt conveying device with crushing and dust-proof functions for agglomerated finely divided materials includes a base 1, a rolling bracket 2, a conveyor belt 3, a crushing and dust removing mechanism 4, and a conveyor belt cleaning mechanism 5.

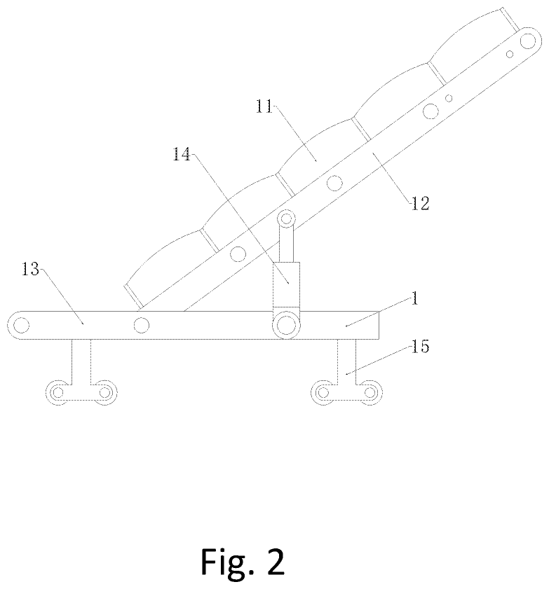

As shown in FIG. 2, the base 1 includes a fixed seat body 13, a movable seat body 12 which is hinged at one end to the fixed seat body 13, and a hydraulic cylinder 14 of which two ends are respectively hinged with the fixed seat body 13 and the movable seat body 12. The fixed seat body 13 is responsible for supporting and the hydraulic cylinder 14 can control the lifting of the movable seat body 12.

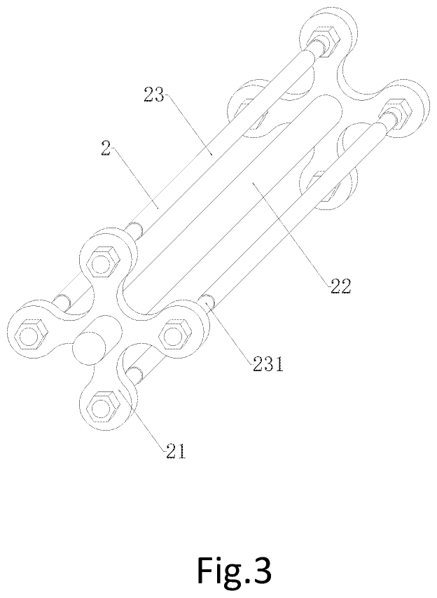

As shown in FIGS. 1 and 3, the rolling bracket 2 is disposed on the base 1. The rolling bracket 2 includes a symmetrically disposed supporting plate 21, a rotating shaft 22 fixedly connected to the supporting plate 21 at both ends, and a plurality of supporting rods 23 fixed to the supporting plate 21 circumferentially along the central axis of the rotating shaft 22. The two ends of the rotating shaft 22 are respectively rotatably connected to the base 1, and are connected to a third motor 20 disposed on the base 1. The central axis of the supporting rod 23 is parallel to the central axis of the rotating shaft 22, and the two ends of the supporting rod 23 are respectively provided with annular grooves 231.

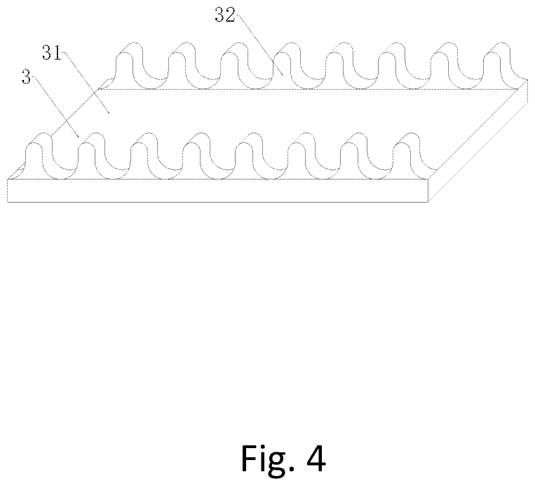

As shown in FIG. 4, the conveyor belt 3 is disposed on the rolling bracket 2.

The conveyor belt 3 includes a belt-shaped conveyor belt body 31 and a plurality of induction teeth 32 uniformly arranged on the conveyor belt body 31 for regulating the conveyor belt 3.

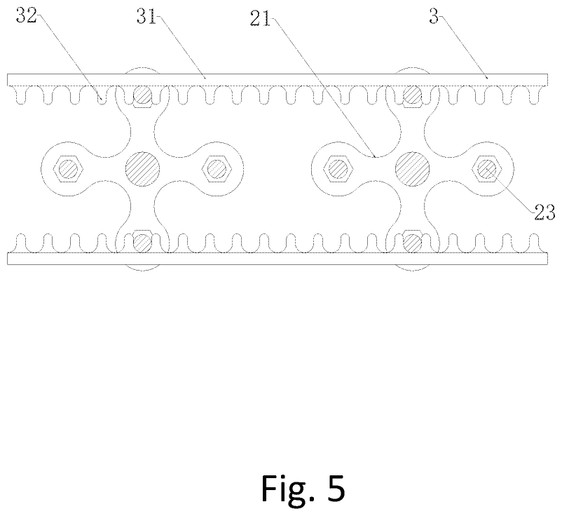

As shown in FIG. 5, the induction tooth 32 is engaged with the annular groove 231 on the supporting rod 23.

In one example embodiment, the bottom surface structure of the annular groove 231 is an arc-shaped structure that smoothly transitions with the supporting rod. The induction tooth 32 can be more easily guided into the annular groove 231 in the vibration of the conveying device itself.

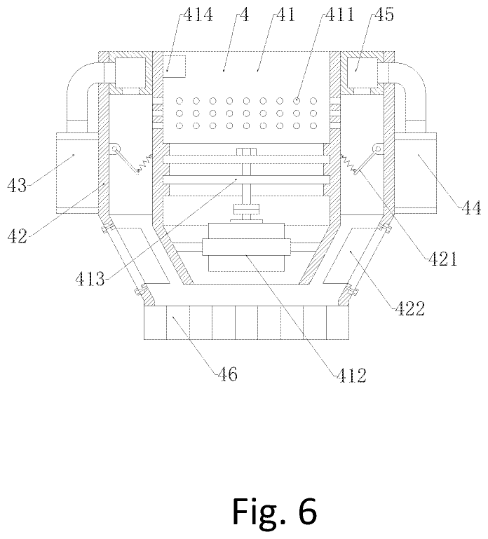

As shown in FIGS. 1 and 6, the crushing and dust removing mechanism 4 is disposed at a feeding end of the conveying device, and the crushing and dust removing mechanism 4 includes an inner sleeve 41, an outer sleeve 42 sleeved on the inner sleeve 41, a first air pump 43, an ion fan 44, and a mixing chamber 45. A gap is defined between the inner sleeve 41 and the outer sleeve 42. The mixing chamber 45 is fixedly disposed at an upper end of the gap.

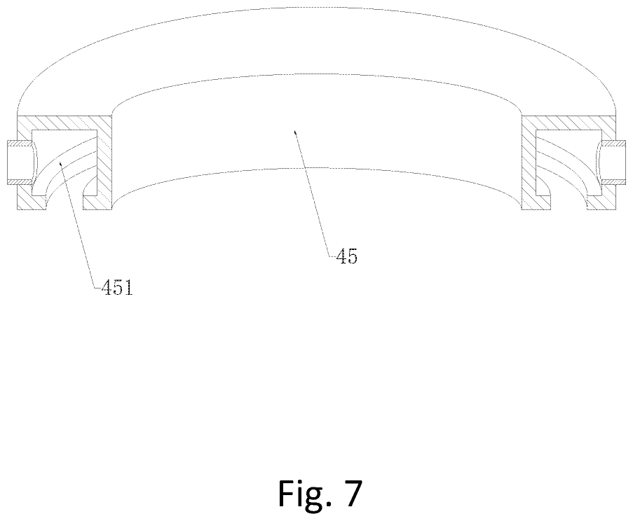

As shown in FIG. 7, the mixing chamber 45 is provided with a mixing cavity 451 having a downward opening. The mixing cavity 451 is respectively connected to the first air pump 43 fixedly disposed on the outer sleeve, and the ion fan 44.

The upper end of the inner sleeve 41 is provided with a plurality of through holes 411 which the dust passes through. The lower end of the inner cavity of the inner sleeve 41 is provided with a first motor 412. The first motor 412 is mutually driven and connected with a plurality of turntables 413 disposed in the middle of the inner cavity of the inner sleeve 41 through the rotating shaft.

The first air pump 43 supplies air to the mixing chamber 45 to generate a downward air flow, to absorb the dust generated in the inner sleeve 41 into the gap between the inner sleeve 41 and the outer sleeve 42 via the through holes 411. Ions generate from the ion fan 44 removes electric charges of dust particles by attaching the dust particles, in order to prevent the dust from attaching on the outer wall of the inner sleeve 41 and the inner wall of the outer sleeve 42 under the action of static electricity.

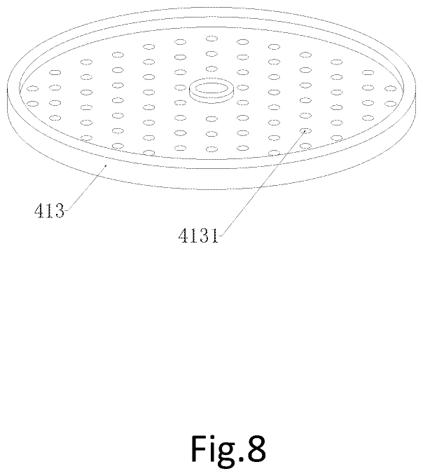

As shown in FIG. 8, a plurality of oblique through holes 4131 are evenly arranged on the turntable 413. In one example embodiment. Two adjacent turntables 413 are rotated in opposite directions by planetary gears 4131.

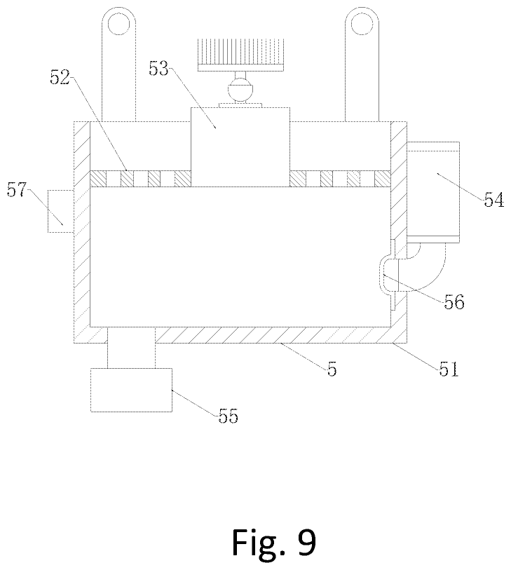

As shown in FIG. 9, the conveyor belt cleaning mechanism 5 is disposed at a discharge end of the conveying device. The conveyor belt cleaning mechanism 5 includes a cylinder 51 fixed to the movable seat body 12 and having an opening facing the conveyor belt 3, a stencil 52 disposed in the inner cavity of the cylinder 51, a cleaning mechanism 53 fixedly arranged on the stencil 52, and a second air pump 54 fixedly disposed on the cylinder 51.

The cleaning mechanism 53 sweeps the residual material on the conveyor belt 3 into the inner cavity of the cylinder 51. The materials pass through the stencil 52 and finally falls into the bottom of the inner cavity of the cylinder 51 under the action of the cylinder 51 pumped out by the second air pump 54.

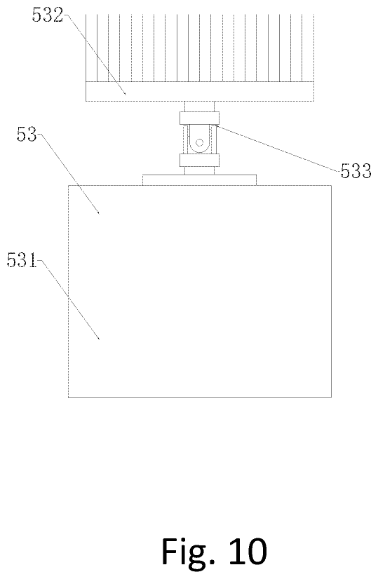

As shown in FIG. 10, the cleaning mechanism 53 includes a second motor 531 fixedly disposed on the stencil 52, a brush 532 and a cardan shaft 533 for connecting the second motor 531 and the brush 532. The second air pump 54 is in communication with the lower end of the inner cavity of the cylinder 51, and the lower end of the inner cavity of the cylinder 51 is provided with an electromagnetic valve 55 for releasing material in the cylinder 51. In one embodiment, the collected material is discharged directly through electromagnetic valve 55. In another embodiment, the electromagnetic valve 55 controls the opening and closing of the valve and the collected material is discharged through the valve.

In one embodiment, the fixed seat body 13 is provided with a plurality of legs 15 with rollers. A locking mechanism is provided with the roller on the leg 15. The fixed seat body 13 is further provided with a double-axis horizontal sensor 17. The a double-axis horizontal sensor 17 is used to detect the horizontal level of the fixed seat 13, and ensure the horizontal level of the base 1 by regulating the controller 16.

In one example, the movable seat body 12 is provided with a dust-proof scaffolding frame 11. The dust-proof scaffolding frame 11 is composed of a plurality of curved supporting rod members connected to the movable seat body 12 and a tarpaulin disposed on the supporting rod member.

In one example, a dust detector 414 is disposed at an upper end of the inner sleeve 41. The dust detector 414 detects the dust concentration, and the measured data thereof is used as control the opening and closing of the first air pump 43 and the ion fan 44.

In one example, when the turntable 413 is punched towards the through hole 4131, the protrusion generated. The protrusion is polished to form a blade which forms a piece structure with the turntable 413, for crushing the agglomerated material.

In one example, the lower end of the outer sleeve 42 is provided with a dust-proof skirt plate 46 and a pressure release port 422 for removing wind pressure. A dust-proof net is arranged on the pressure release port 422. Most of the downward wind carrying the dust is discharged through the pressure release port 422, so as to avoid blowing dust to the conveyor belt 3 to cause new dust. A small portion of the residual downwind is filtered by dust-proof net and the filtered dust is sent to the conveyor belt 3 for transportation.

In one example, the gap between the inner sleeve 41 and the outer sleeve 42 is provided with a pressure reducing plate 421. One end of the pressure reducing plate 421 and the outer sleeve 42 are hinged to each other, and the other end of the pressure reducing plate 421 is connected to the inner sleeve 41 by a spring. The pressure reducing plate 421 should be disposed below the horizontal line of the through hole 411, and its function is to slow down the wind speed and avoid causing new dust.

In one example, a fan filter 56 is disposed at the junction of the second air pump 54 and the inner cavity of the cylinder 51.

In one example, the conveyor belt cleaning mechanism 5 is provided with an angle sensor 57. The height of the conveyance is obtained by the measuring the inclination angle, and the controller 16 controls the lifting of the movable base 12 based on the data.

In one example, the base 1 is further provided with a controller 16. The controller 16 is respectively electrically connected with a hydraulic pump for controlling the hydraulic cylinder 14, the first air pump 43, the ion fan 44, the first motor 412, the second air pump 54, the second motor 531, a double-axis horizontal sensor 17, a dust detector 414, the angle sensor 57, the electromagnetic valve 55, and the third motor 20.

The belt conveying device with crushing and dust-proof functions for agglomerated finely divided materials of the invention includes a base, a rolling bracket, a conveyor belt, a crushing and dust removing mechanism, and a conveyor belt cleaning mechanism. The annular groove on the rolling bracket is engagement with the induction tooth on the conveyor belt to automatically regulate each other to prevent the deviation of the conveyor belt. On one hand, the crushing and dust removing mechanism crushes agglomerated finely divided materials. On the other end, the dust is absorbed into the crushing and dust removing mechanism via wind power to remove dust. The conveyor belt cleaning mechanism cleans the finely divided materials attached on the conveyor belt. The operation of each mechanism is controlled by the controller, and each sensor monitors the running status in real time with high degree of intelligence. It has advantages of having simple and reasonable structure, easy to use, high degree of intelligence, automatically correcting deviation of conveyor belt and cleaning the conveyor belt and good dust-proof effect, which effectively solves the problem of jeopardizing the health of workers due to the dust caused at the time of conveying finely divided materials.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A belt conveying device with crushing and dust-proof functions for agglomerated finely divided materials, comprising: a base 1, a rolling bracket 2, a conveyor belt 3, a crushing and dust removing mechanism 4, and a conveyor belt cleaning mechanism 5,
wherein the base 1 includes a fixed seat body 13, a movable seat body 12 which is hinged at one end to the fixed seat body 13, and a hydraulic cylinder 14 of which two ends are respectively hinged with the fixed seat body 13 and the movable seat body 12;
wherein the rolling bracket 2 is disposed on the base 1; the rolling bracket 2 includes a symmetrically disposed supporting plate 21, a rotating shaft 22 fixedly connected to the supporting plate 21 at both ends, and a plurality of supporting rods 23 fixed to the supporting plate 21 circumferentially along the central axis of the rotating shaft 22; the two ends of the rotating shaft 22 are respectively rotatably connected to the base 1, and are connected to a third motor 20 disposed on the base 1; the central axis of the supporting rod 23 is parallel to the central axis of the rotating shaft 22, and the two ends of the supporting rod 23 are respectively provided with annular grooves 231,
wherein the conveyor belt 3 is disposed on the rolling bracket 2; the conveyor belt 3 includes a belt-shaped conveyor belt body 31 and a plurality of induction teeth 32 uniformly arranged on the conveyor belt body 31 for regulating the conveyor belt 3; the induction tooth 32 is engaged with the annular groove 231 on the supporting rod 23,
wherein the crushing and dust removing mechanism 4 is disposed at a feeding end of the conveying device, and the crushing and dust removing mechanism 4 includes an inner sleeve 41, an outer sleeve 42 sleeved on the inner sleeve 41, a first air pump 43, an ion fan 44, and a mixing chamber 45; a gap is defined between the inner sleeve 41 and the outer sleeve 42; the mixing chamber 45 is fixedly disposed at an upper end of the gap; the mixing chamber 45 is provided with a mixing cavity 451 having a downward opening; the mixing cavity 451 is respectively connected to the first air pump 43 fixedly disposed on the outer sleeve, and the ion fan 44,
wherein the upper end of the inner sleeve 41 is provided with a plurality of through holes 411 which the dust passes through; the lower end of the inner cavity of the inner sleeve 41 is provided with a first motor 412; the first motor 412 is mutually driven and connected with a plurality of turntables 413 disposed in the middle of the inner cavity of the inner sleeve 41 through the rotating shaft; a plurality of oblique through holes 4131 are evenly arranged on the turntable 413,
wherein the conveyor belt cleaning mechanism 5 is disposed at a discharge end of the conveying device; the conveyor belt cleaning mechanism 5 includes a cylinder 51 fixed to the movable seat body 12 and having an opening facing the conveyor belt 3, a stencil 52 disposed in the inner cavity of the cylinder 51, a cleaning mechanism 53 fixedly arranged on the stencil 52, and a second air pump 54 fixedly disposed on the cylinder 51; the cleaning mechanism 53 includes a second motor 531 fixedly disposed on the stencil 52, a brush 532 and a cardan shaft 533 for connecting the second motor 531 and the brush 532; the second air pump 54 is in communication with the lower end of the inner cavity of the cylinder 51, and the lower end of the inner cavity of the cylinder 51 is provided with an electromagnetic valve 55 for releasing material in the cylinder 51.

2. The belt conveying device with crushing and dust-proof functions for agglomerated finely divided materials of claim 1, wherein the fixed seat body 13 is provided with a plurality of legs 15 with rollers; a locking mechanism is provided with the roller on the leg 15; the fixed seat body 13 is further provided with a double-axis horizontal sensor 17.

3. The belt conveying device with crushing and dust-proof functions for agglomerated finely divided materials of claim 1, wherein the movable seat body 12 is provided with a dust-proof scaffolding frame 11; the dust-proof scaffolding frame 11 is composed of a plurality of curved supporting rod members connected to the movable seat body 12 and a tarpaulin disposed on the supporting rod member.

4. The belt conveying device with crushing and dust-proof functions for agglomerated finely divided materials of claim 1, wherein a dust detector 414 is disposed at an upper end of the inner sleeve 41.

5. The belt conveying device with crushing and dust-proof functions for agglomerated finely divided materials of claim 1, wherein when the turntable 413 is punched towards the through hole 4131, the protrusion generated; the protrusion is polished to form a blade which forms a piece structure with the turntable 413, for crushing the agglomerated material.

6. The belt conveying device with crushing and dust-proof functions for agglomerated finely divided materials of claim 1, wherein the lower end of the outer sleeve 42 is provided with a dust-proof skirt plate 46 and a pressure release port 422 for removing wind pressure; a dust-proof net is arranged on the pressure release port 422.

7. The belt conveying device with crushing and dust-proof functions for agglomerated finely divided materials of claim 1, wherein the gap between the inner sleeve 41 and the outer sleeve 42 is provided with a pressure reducing plate 421; one end of the pressure reducing plate 421 and the outer sleeve 42 are hinged to each other, and the other end of the pressure reducing plate 421 is connected to the inner sleeve 41 by a spring.

8. The belt conveying device with crushing and dust-proof functions for agglomerated finely divided materials of claim 1, wherein a fan filter 56 is disposed at the junction of the second air pump 54 and the inner cavity of the cylinder 51.

9. The belt conveying device with crushing and dust-proof functions for agglomerated finely divided materials of claim 1, wherein the conveyor belt cleaning mechanism 5 is provided with an angle sensor 57.

10. The belt conveying device with crushing and dust-proof functions for agglomerated finely divided materials of claim 1, wherein the base 1 is further provided with a controller 16; the controller 16 is respectively electrically connected with a hydraulic pump for controlling the hydraulic cylinder 14, the first air pump 43, the ion fan 44, the first motor 412, the second air pump 54, the second motor 531, a double-axis horizontal sensor 17, a dust detector 414, the angle sensor 57, the electromagnetic valve 55, and the third motor 20.
